(19) United States
(12) Patent Application Publication
(10) Pub. No.: US 2016/0239827 A1
(43) Pub. Date: Aug. 18, 2016

(54) SYSTEMS AND METHODS FOR GIFT CARD EXCHANGE

(71) Applicant: MYPOINTS.COM INC., San Francisco, CA (US)

(72) Inventors: Ananth Annam Reddy, Dublin, CA (US); Sha Fakiri, Pleasanton, CA (US); Nathan Sweet, San Francisco, CA (US)

(21) Appl. No.: 15/040,574

(22) Filed: Feb. 10, 2016

Related U.S. Application Data
(60) Provisional application No. 62/116,203, filed on Feb. 13, 2015.

(51) Int. Cl. G06Q 20/34; G06Q 20/36; G06Q 20/42

(52) U.S. Cl. CPC G06Q 20/342; G06Q 20/354; G06Q 20/42; G06Q 20/367

(57) ABSTRACT

Methods and systems for implementing a gift card exchange are described. According to aspects, a purchasing user may purchase, via a server, a gift card for a recipient user, where the gift card specifies a redemption amount and a merchant. The server may notify the recipient user of the gift card purchase. The recipient user may either claim the gift card or exchange the gift card. If the recipient user selects to exchange the gift card, the recipient user may browse a set of alternate merchants that offer gift cards and select one of the set of alternate merchants. The server may provide the recipient user with a redeemable gift code for the selected alternate merchant.

### Cross-Reference to Related Applications

This application claims benefit of the filing date of U. S. Provisional Patent Application No. 62/116,203 (filed Feb. 13, 2016 and entitled “SYSTEMS AND METHODS FOR GIFT CARD EXCHANGE”), the disclosure of which is hereby incorporated by reference in its entirety.

### FIELD OF THE DISCLOSURE

The present disclosure generally relates to systems and methods for processing gift cards and other items. More particularly, the present disclosure relates to platforms and techniques for enabling a recipient of a gift card or other item to select an issuing merchant for the gift card or other item.

### BACKGROUND

Gift cards are a popular item for people to give to each other as gifts. Generally, a gift card is a restricted monetary equivalent that may be issued by banks, retailers, or merchants, and that may be used an alternative to a non-monetary gift. A purchased gift card has a specified redemption amount or denomination (e.g., $5, $50, $100, etc.) as well as a specified merchant or retailer where the gift card is accepted. The gift card includes a unique barcode or other identification that enables the recipient to redeem the gift card with the specified merchant or retailer.

By their nature, gift cards enable a purchaser to purchase a gift (i.e., the gift card) when the purchaser does not know what, exactly, a recipient of the gift would like. However, it is often the case that the recipient does not want any good or service that is offered by a merchant associated with the purchased gift card. Indeed, research shows that over 20% of purchased gift cards go unredeemed or unused. Even though there exist some platforms and marketplaces that enable individuals to sell issued gift cards for cash or other consideration, the individuals still must go through the hassle of selling the gift cards and coordinating payment with the buyer and/or the marketplace.

Therefore, there is an opportunity for systems and methods that enable the purchase and/or exchange of gift cards that recipients will ultimately want to redeem without the need for a third-party marketplace.

### SUMMARY

In an embodiment, a computer-implemented method of implementing a gift card exchange is provided. The method includes receiving, from a first electronic device, a request to purchase a gift card specifying (i) a redemption amount, (ii) a merchant, and (iii) a recipient, and completing, by a processor, a purchase of the gift card with a payment processing entity, the purchase having a redeemable gift code associated therewith. Responsive to completing the purchase, the method includes sending a confirmation of the purchase of the gift card to the first electronic device, and sending, to a second electronic device associated with the recipient, a reference to the gift card. The method further includes receiving, from the second electronic device, an exchange request to switch the merchant of the gift card to an alternate merchant, accessing an alternate redeemable gift code, for the gift card, associated with the alternate merchant, and sending the alternate redeemable gift code to the second electronic device.

In another embodiment, a system for implementing a gift card exchange is provided. The system includes a transceiver configured to communicate with a first electronic device associated with a sending user, a second electronic device associated with a recipient user, and a payment processing entity. The system further includes a memory storing (i) a set of computer-executable instructions and (ii) a set of gift card processing data, and a processor adapted to interface with the transceiver and the memory. The processor is configured to execute the set of computer-executable instructions to cause the processor to receive, from the first electronic device via the transceiver, a request to purchase a gift card specifying (i) a redemption amount, (ii) a merchant, and (iii) the recipient user, and complete a purchase of the gift card with the payment processing entity, the purchase having a redeemable gift code associated therewith. Responsive to completing the purchase, the processor is configured to send, to the first electronic device via the transceiver, a confirmation of the purchase of the gift card to the first electronic device, and send, to the second electronic device via the transceiver, a reference to the gift card. The processor is further configured to receive, from the second electronic device via the transceiver, an exchange request to switch the merchant of the gift card to an alternate merchant, access an alternate redeemable gift code, for the gift card, associated with the alternate merchant, and send the alternate redeemable gift code to the second electronic device via the transceiver.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts a system diagram including various components and entities associated with a gift card exchange, in accordance with some embodiments.

FIG. 2 depicts a signal diagram illustrating communications associated with a gift card exchange, in accordance with some embodiments.

FIG. 3 depicts a block diagram associated with a gift card exchange, in accordance with some embodiments.

FIG. 4 is a block diagram of an electronic device, in accordance with some embodiments.

FIG. 5 is a block diagram of a server, in accordance with some embodiments.

FIGS. 6A-6I depict exemplary user interfaces associated with exchanging gift cards, in accordance with some embodiments.

### DETAILED DESCRIPTION

The novel systems and methods disclosed herein relate generally to implementing a gift card exchange. According to certain aspects, a purchasing user may purchase a gift card that specifies a denomination, a merchant, and a recipient user. The systems and methods enable the recipient of a gift card to either claim or exchange the gift card. If the recipient claims the gift card, the systems and methods will provide the recipient with a gift code for the gift card that is redeemable with the merchant. If the recipient exchanges the gift card, the systems and methods enable the recipient to select an alternate merchant and ultimately provide the recipient with a gift code that is redeemable with the alternate merchant.

The gift card exchange as detailed herein differs from conventional gift card systems in multiple respects. There are some existing marketplaces that enable users to purchase and/or sell already-issued gift cards. In particular, a user accesses the marketplaces to “post” a gift card for others to purchase and/or to view other gift cards that are available for purchase. In contrast to these marketplaces, the current systems and methods do not “issue” a gift code associated with a purchased gift card to a recipient user until the merchant for the gift card is ascertained. According to implementations, the merchant may be ascertained when the recipient user selects to claim a purchased gift card or when the recipient user selects an alternate merchant for the gift card.

Accordingly, the systems and methods offer numerous benefits over existing platforms. In particular, the systems and methods offer the recipient user the ability to select an alternate merchant that may be more relevant to or otherwise desired by the recipient user. Further, a purchasing or sending user may feel confident that the recipient user will either claim the gift card for the originally-specified merchant or exchange the gift card to a more-desired merchant. Additionally, the recipient user will not have to sell an undesired gift card via a marketplace or even purchase a desired gift card via the marketplace.

It should be appreciated that the gift cards as described throughout this application may be in the form of “e-gift” cards that may not have an associated physical gift card, and may be redeemable via e-commerce websites and/or within physical “brick and mortar” stores. Although the systems and methods described herein relate to the purchase and exchange of gift cards, it should be appreciated that the systems and methods contemplate the purchase and exchange of other items that may be offered by retailers or merchants. The items may be in the form of a credit (e.g., a discount, reward points, etc.), a service (e.g., a massage, a haircut, etc.), or a tangible good (e.g. a pair of shoes, a book, etc.). In some implementations, the systems and methods may enable a user to exchange an item offered by one merchant for the same item offered by another merchant. For example, the user may want to specify an alternate merchant if the user is part of a rewards program with the alternate merchant. In other implementations, the systems and methods may enable the user to exchange an item offered by one merchant for a similar item (or different item altogether) offered by another merchant. For example, if the user is offered a smartphone of a particular manufacturer and prefers a different smartphone, then the user may specify the different smartphone as well as an alternate manufacturer that offers the different smartphone.

The systems and methods discussed herein address a business challenge, namely a business challenge related to improving the gift giving industry. This is particularly apparent in an ecommerce context in which individuals purchase e-gift cards for each other. In conventional situations, a gift giving individual purchases a gift card for and sends the gift card to a recipient individual, where the gift card is only redeemable at a specified merchant. In contrast, the systems and methods utilize network connections and electronic tokens to enable a recipient individual to exchange an originally-purchased gift card associated with a specified merchant with a gift cards associated with an alternative merchant, where the new gift card may be more desired by the recipient individual.

Therefore, the systems and methods do not merely recite the performance of some business practice known from the pre-Internet world (purchasing gift cards) along with the requirement to perform it on the Internet. Instead, the systems and methods are necessarily rooted in computer technology in order to overcome a problem specifically airing in computer networks.

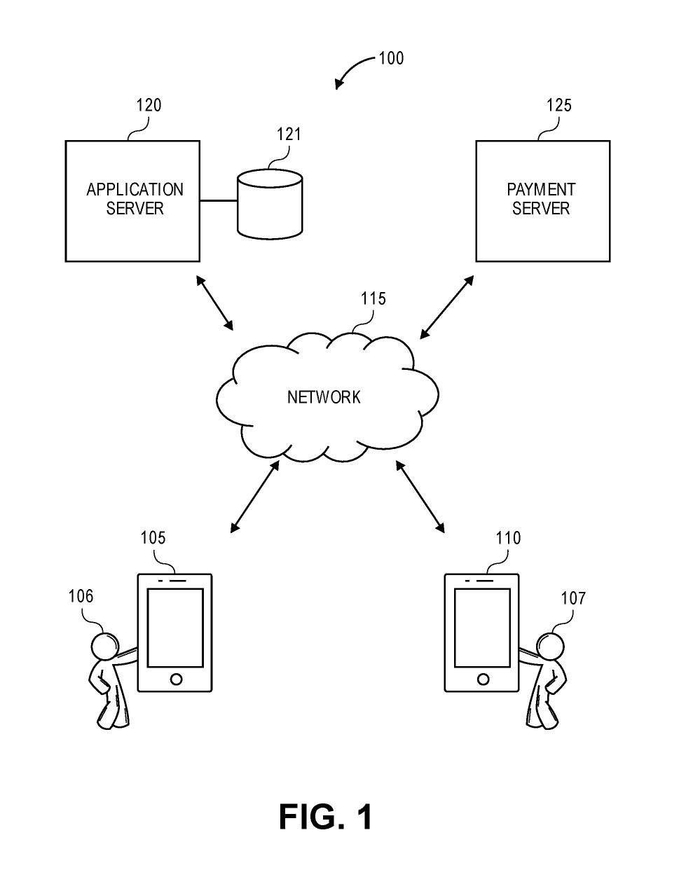

FIG. 1 depicts a system 100 that supports gift card transactions and exchanges. Although FIG. 1 depicts certain entities, components, and devices, it should be appreciated that additional or alternate entities and components are envisioned.

As illustrated in FIG. 1, the system 100 includes a set of electronic devices: a sending device 105 and a receiver device 110. Generally, each of the sending device 105 and the receiver device 110 may be any type of electronic device such as, for example a smartphone, notebook computer, tablet, phablet, GPS (Global Positioning System) or GPS-enabled device, smart watch, smart glasses, smart bracelet, wearable electronic device, PDA (personal digital assistants), pager, computing device configured for wireless communication, and/or the like. The sending device 105 is capable of being operated by a sending user 106 and the receiver device 110 is capable of being operated by a receiver user 107.

The system 100 further includes an application server 120 and a payment server 125. The sending device 105, the receiver device 110, the application server 120, and the payment server 125 may communicate with each other via one or more networks 115. The network(s) 115 can facilitate any type of data communication via any standard or technology (e.g., GSM, CDMA, TDMA, WCDMA, LTE, EDGE, OFDM, GPRS, EV-DO, UWB, IEEE 802 including Ethernet, WiMAX, Wi-Fi, and/or others). In some implementations, the network(s) 115 may support various short range communications (e.g., Bluetooth®, RFID, NFC) between the sending device 105 and the receiver device 110.

Each of the application server 120 and the payment server 125 may be a combination of hardware and software components associated with any individual, group of individuals, company, corporation, or other type of entity. According to embodiments, the application server 120 may facilitate various gift card processing and exchanging functionalities. In particular, the application server 120 may support and/or interface with a communication platform via which the users 106, 107 may purchase, exchange, claim, and redeem gift cards. The communication platform may be any type of interface that enables communication such as, for example, a dedicated application, website, and/or the like. In some implementations, the application server 120 may interface with one or more merchants (not shown in FIG. 1) to purchase an inventory of gift cards, wherein the gift cards may have various redemption amounts, gift codes, expiration dates, and/or other relevant data. For example, the application server 120 may purchase an inventory of five (5) $25 gift cards and ten (10) $100 gift cards from one merchant, and twenty (20) $5 gift cards and fifteen (15) $50 gift cards from another merchant.

The gift cards in the inventory may then be available for purchase by users, such as the sending user 106. In operation, the sending user 106 may use the sending device 105 to send a request to the application server 120 to purchase a gift card. The application server 120 and the sending device 105 may interface with the payment server 125 to facilitate a purchase of a gift card. According to embodiments, the gift card may have a redemption amount or denomination (e.g., $5, $50, $100, etc.) as well as a specified merchant or retailer where the gift card may be redeemed. The merchant or business may be any entity that offers a good or a service for purchase by consumers, and may have an associated brick and mortar (B&M) location(s) and/or a website store or storefront. For example, the sending user 106 may purchase a gift card in the amount of $100 that is redeemable at a sporting goods merchant that has both a B&M store and an e-commerce website.

Generally, each gift card may have a number or code that has associated data related to the gift card, such as the gift card amount or balance and/or expiration date. The number or code may be a unique number or code so as to ensure that no two gift cards are the same. In this regard, the merchant associated with the gift card may be able to accurately manage redemption of the gift card. In some implementations, such as if the application server 120 does not initially purchase an inventory of gift cards, the application server 120 and the payment server 125 may interface or communicate with various merchants (not shown in FIG. 1) to facilitate the purchase, exchange, and/or redemption of gift cards that are specified in respective purchase requests. In particular, the payment server 125 may ultimately process a payment for a merchant specified in a gift card purchase. In this implementation, the application server 120 may utilize an escrow account to facilitate payment.

Each of the sending device 105 and the receiver device 110 may support a communication platform capable of communication with the application server 120 and the payment server 125. For example, the communication platform may be a dedicated application, website, and/or the like. The communication platform may display information for review by the respective users 106, 107, such as via a user interface of the respective devices 105, 110, and may also transmit data and selections to the application server 120 and/or the payment server 125. In operation, the sending user 106 may interface with the sending device 105 to purchase a gift card for the receiver user 107 of the receiver device 110. The sending user 106 may specify the redemption amount as well as the merchant for the gift card. The communication platform of the sending device 105 may interface with the application server 120 and the payment server 125 to “reserve” the gift card in the specified redemption amount for the specified merchant. In particular, the payment server 125 may collect payment for the gift card and the application server 120 may access or generate a redeemable gift code that is associated with the gift card.

After the sending user 106 purchases the gift card, the application server 120 may communicate an indication of the gift card to the receiver user 107, or otherwise notify the receiver user 107 of the gift card. According to embodiments, the application server 120 may notify the receiver user 107 via a communication platform (e.g., a dedicated application, a website, and/or the like), or may send an electronic communication to an address or contact associated with the receiver user 107. For example, the application server 120 may notify the receiver user 107 of the purchased gift card via an email, text message, push notification, phone call, and/or other type of communication. The receiver user 107 may then access an appropriate application of the receiver device 110 to view details associated with the purchased gift card. In some implementations, the sending device 105 may communicate directly with the receiver device 110 to notify of the gift card purchase.

According to embodiments, the receiver device 110 may enable the receiver user 107 to select to claim the gift card or exchange the gift card. If the receiver user 107 selects to the claim the gift card, the receiver device 110 may interface with the application server 120 to commit to the gift card, whereby the application server 120 may provide a redeemable gift code to the receiver device 110 or otherwise enable the receiver device 110 to access the redeemable gift code.

In contrast, if the receiver user 107 selects to exchange the gift card, the receiver device 110 may enable the receiver user 107 to browse alternate gift cards that are available for purchase (which may or may not be for the same amount of the originally-purchased gift card) and ultimately select one of the additional gift cards. The alternate gift cards may be associated with merchants alternate to the merchant specified in the original gift card purchase. The receiver device 110 may then interface with the application server 120 to commit to the alternate gift card associated with the alternate merchant, whereby the application server 120 may provide an alternate redeemable gift code to the receiver device 110 or otherwise enable the receiver device 110 to access the alternate redeemable gift code.

The application server 120 may interface with a database 121 to store accounts or profiles associated with the sending user 106 and the receiving user 107. In some implementations, the database 121 may store or support digital wallets for each of the sending user 106 and the receiving user 107 that specify any gift cards that are available for use. The database 121 may also maintain data records associated with the gift cards, where the records may indicate associated gift codes, recipient information, expiration dates, claimed/unclaimed status, and/or other information.

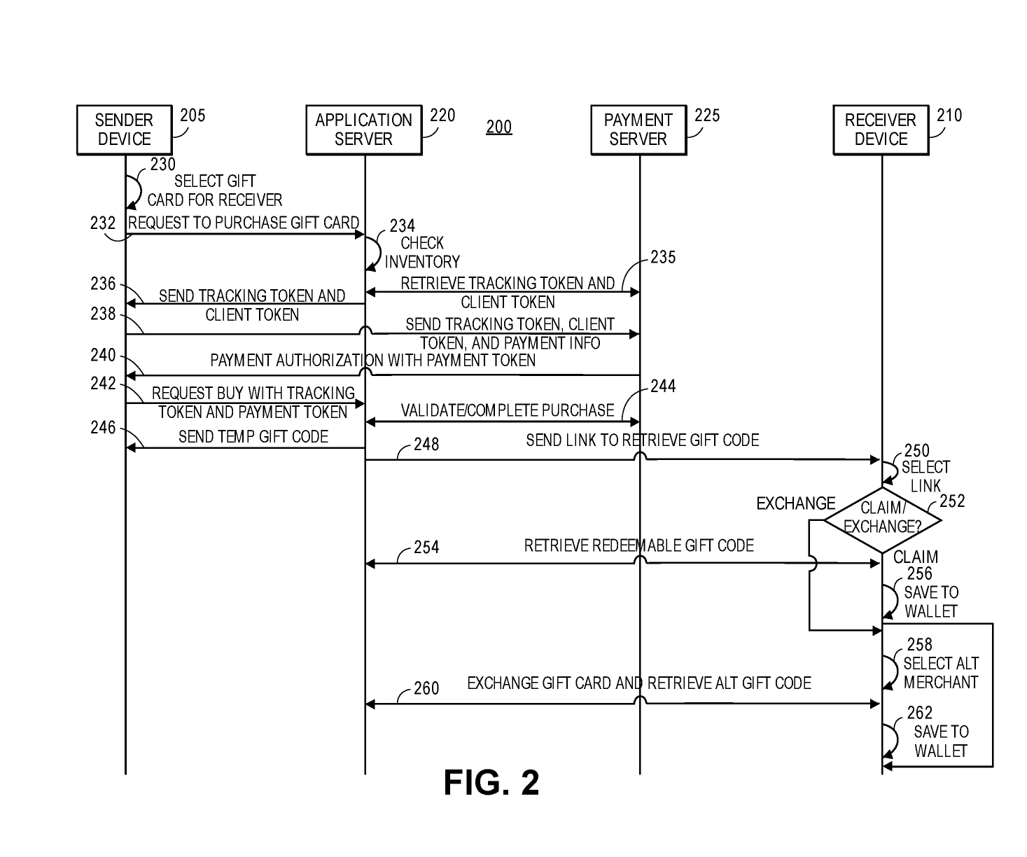

FIG. 2 illustrates a signal diagram 200 describing communications among the various components that may be used to implement the present embodiments. The signal diagram 200 includes a sender device 205 (such as the sender device 105 as discussed with respect to FIG. 1), an application server 220 (such as the application server 120 as discussed with respect to FIG. 1), a payment server 225 (such as the payment server 125 as discussed with respect to FIG. 1), and a receiver device 210 (such as the receiver device 110 as discussed with respect to FIG. 1).

Each of the sender device 205 and the receiver device 210 may be operable by respective users (e.g., a sender user and a receiver user). Further, each of the sender device 205 and the receiver device 210 may support a communication platform (e.g., a dedicated application, website, and/or the like) which is capable of communication with the application server 220 and the payment server 225. In one embodiment, each of the sender device 205 and the receiver device 210 may both install a dedicated application associated with gift card processing, such as an application offered by and/or supported by the application server 220. In some implementations, at least a portion of the functionalities may be disabled or otherwise not operable without installation of the communication platform on the respective devices 205, 210.

Referring to FIG. 2, the signal diagram 200 may begin when the sender device 205 enables a user to select (230) a gift card for a user of the receiver device 210 (i.e., a recipient). The gift card may specify a redemption amount or denomination, a merchant, the recipient (i.e., the user of the receiver device 210), contact identification associated with the recipient (e.g., an email address, phone number, screen name, and/or the like), and/or an expiration date. In embodiments, the user may make the selections via a dedicated application or other communication platform associated with the sender device 205.

Responsive to the selection of the gift card, the sender device 205 may send (232) a request to the application server 220 to purchase the gift card. In particular, the request may be a request to reserve inventory for the gift card. In operation, the request may be in the form of an API call to an associated application supported by the application server 220. The application server 220 may check (234) an inventory to confirm the ability to purchase/issue a gift card based on the parameters specified in the request (e.g., the redemption amount, the merchant, and/or the expiration date). In particular, the application server 220 may check an inventory of previously-purchased gift cards from various merchants.

After confirming the ability to purchase/issue the gift card (i.e., the requested gift card is included in the inventory), the application server 220 may facilitate various actions necessary for the purchase of the gift card. In particular, the application server 220 may interface with the payment server 225 to retrieve (235) a tracking token and a client token. According to embodiments, the tracking token may be a unique token corresponding to the gift card purchase and the client token may be a unique token corresponding to the sender device 205 and/or to the user thereof. The application server 220 may send (236) the tracking token and the client token to the sender device 205.

After receiving the tracking token and the client token, the sender device 205 may enable its user to input payment information (e.g., a credit card number, a debit card number, bank account information, etc.) to enable payment for the gift card, as well as make a selection to complete the gift card purchase. The sender device 205 may then send (238) the tracking token, the client token, and the payment information to the payment server 225. Upon receiving the tracking token, the client token, and the payment information, the payment server 225 may authorize payment and generate a corresponding payment token, and provide (240) the payment token to the sender device 205.

At 242, the sender device 205 may submit, to the application server 220, a request to purchase or buy the gift card with the tracking token and the payment token. The application server 220 may validate and complete (244) the purchase of the gift card with the payment server 225. In particular, the application server 220 may make an API call to the payment server 225 to validate payment authorization and complete payment by sending the tracking token, the payment token, and the purchase amount. The payment server 225 may then acknowledge success or failure of the purchase. If the purchase succeeds, the application server 220 may make an API call to the payment server 225 to commit payment. If the purchase fails, the application server 220 may make an API call to the payment server 225 to void payment.

After the purchase of the gift card is complete, the application server 220 may generate or access a redeemable gift code associated with the gift card. In embodiments, the application server 220 may interface with a third-party entity (e.g., the merchant itself) to retrieve or reconcile the redeemable gift code. The redeemable gift code may be a unique code that is usable to an end user (e.g., the user of the sender device 205) to redeem the gift card for any specified good(s) and/or service(s). However, because the systems and methods enable users to exchange the gift card from the originally-specified merchant to an alternate merchant, the application server 220 may generate a temporary gift code that is mapped to the redeemable gift code and send (246) the temporary gift code to the sender device 205. In this regard, a user of either the sender device 205 or the receiver device 210 may not have access to the redeemable gift code without first claiming the gift card or exchanging the gift card. The application server 220 may also send a confirmation of the gift card purchase to the sender device 205.

The application server 220 may also generate a communication intended for the receiver device 210 and/or the receiver user thereof, where the communication may include a link to retrieve the redeemable gift code. The application server 220 may send (248) the communication containing the link to retrieve the redeemable gift code to the receiver device 210. It should be appreciated that the application server 220 may send the communication via various channels. For example, the communication may be sent via the dedicated application, as a text message or email, or as another type of electronic communication, whereby the receiver user may use the receiver device 210 to access the electronic communication.

The receiver device 210 may enable its user to select (250) the link associated with the redeemable gift code. In particular, the user may select the link via the communication platform (e.g., browser application, dedicated application, etc.). In some implementations, the user selecting the link may cause the receiver device 210 to prompt the user to download and install a dedicated application. In this scenario, the user may access details associated with the purchased gift card after the dedicated application is installed on the receiver device 210.

After the user selects the link, the receiver device 210 may prompt (252) the user with an option to either claim the gift card or exchange the gift card. If the user selects to claim the gift card (“CLAIM”), the receiver device 210 may retrieve (254) the redeemable gift code from the application server 220. In one embodiment, the receiver device 210 may make a “commit” API call to the application server 220 to request the redeemable gift code. The application server 220 may provide the redeemable gift code to the receiver device 210 and the receiver device 210 may display the redeemable gift code. The application server 220 may also update its records or memory to reflect that the gift card has been claimed. The receiver device 210 may also enable (256) the user to save the redeemable gift code to a digital wallet. According to embodiments, the digital wallet may be an organization tool or record that stores references to the redeemable gift code and any other redeemable gift codes available to the user. Further, the digital wallet may be a feature of the dedicated application or a feature of an operating system executing on the receiver device 210. In this regard, the user may access the digital wallet to ascertain any gift cards available for redemption.

If the user selects to exchange the gift card (“EXCHANGE”), the receiver device 210 may enable the user to select (258) an alternate merchant for the gift card. In one embodiment, the receiver device 210 may retrieve a list of alternate merchants from the application server 220 that have gift cards available in lieu of the originally-purchased/reserved gift card. The receiver device 210 may enable the user to scroll through or view the list of alternate merchants and the user may select a desired alternate merchant from the list. For example, if the originally-purchased gift card is for a particular sporting goods merchant, the alternate merchants may include alternate sporting goods merchants and/or other non-sporting goods merchants. In some implementations, the receiver device 210 may require a dedicated application to be installed on the receiver device 210 for the user to be able to select the alternate merchant.

After the user selects the alternate merchant, the receiver device 210 may interface with the application server 220 to switch or exchange (260) the gift card and retrieve an alternate gift code associated with the alternate merchant. In one implementation, the receiver device 210 may make an API call to the application server 220 to cause the application server 220 to switch the originally-purchased/reserved gift card to an alternate gift card associated with the alternate merchant. The application server 220 may also generate or access the alternate gift code that is associated with the alternate gift card, where the alternate gift code is redeemable for any good(s) and/or service(s) offered by the alternate merchant. In embodiments, the application server 220 may interface with a third-party entity (e.g., the alternate merchant itself) to retrieve or reconcile the alternate gift code.

The application server 220 may also send or provide the alternate gift code to the receiver device 210 and the receiver device 210 may display the alternate gift code. In some implementations, the application server 220 may communicate the alternate gift code to an identification associated with the receiver user (e.g., email address, phone number, etc.), and the receiver user may use the receiver device 210 to access the alternate gift code. The receiver device 210 may also enable (262) the user to save the alternate gift code to a digital wallet. According to embodiments, the digital wallet may be an organization tool that stores references to the alternate gift code and any other redeemable gift codes available to the user. Further, the digital wallet may be a feature of the dedicated application or a feature of an operating system executing on the receiver device 210. In this regard, the user may access the digital wallet to ascertain any gift cards available for redemption.

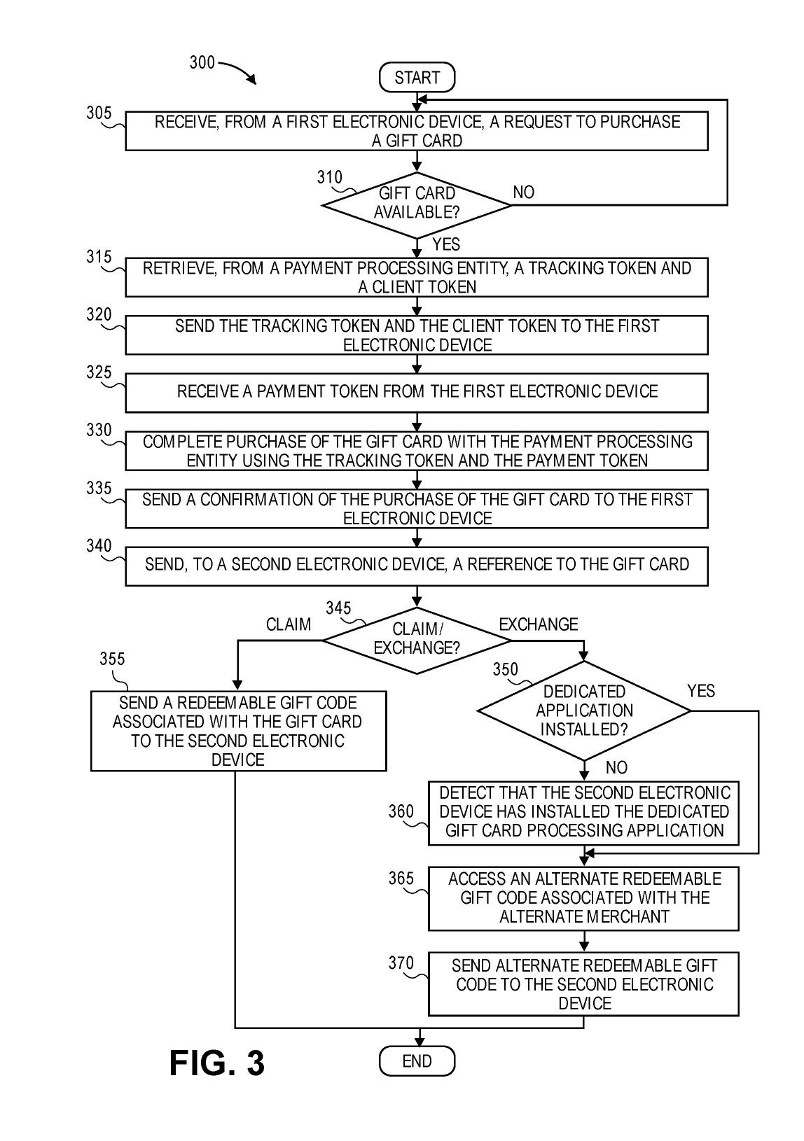

Referring to FIG. 3, depicted is a block diagram of an example method 300 for implementing a gift card exchange. The method 300 may be facilitated by a server, such as the application server 120 as discussed with respect to FIG. 1. The server may communicate with various devices and entities, including a first electronic device (such as the sending device 105 as discussed with respect to FIG. 1), a second electronic device (such as the receiving device 110 as discussed with respect to FIG. 1), and a payment processing entity (such as the payment server 125 as discussed with respect to FIG. 1). The server may also interface with a dedicated application that may be installed on the first and second electronic devices.

The method 300 may begin with the server receiving (block 305), from the first electronic device, a request to purchase a gift card. The request may specify a redemption amount, a merchant, a recipient, and/or a communication channel associated with the recipient (e.g., email address, phone number, screen name, etc.). The server may determine (block 310) whether the gift card is available or otherwise if the gift card may be reserved. If the gift card is not available (“NO”), the server may enable a user of the first electronic device to modify any of the parameters of the gift card.

If the gift is available (“YES”), the server may retrieve (block 315), from a payment processing entity, a tracking token and a client token, where the tracking token may be associated with the purchase itself and the client token may be associated with the first electronic device. The server may send (block 320) the tracking token and the client token to the first electronic device. In embodiments, the first electronic device may exchange payment information with the payment processing entity, and the server may subsequently receive (block 325) a payment token from the first electronic device. The server may complete (block 330) a purchase of the gift card with the payment processing entity using the tracking token and the payment token. At this point, the server may have access to a redeemable gift code for the gift card.

The server may send (block 335) a confirmation of the purchase of the gift card to the first electronic device. The confirmation may include a temporary gift code that is mapped to the redeemable gift code. The server may also send (block 340), to the second electronic device, a reference to the gift card. The reference may be in the form of a link or other selectable object. In addition to the reference, the server may also send information associated with the gift card (e.g., redemption amount, specified merchant, etc.) to the second electronic device. In sending the reference to the gift card, the server may send an electronic communication to an identification (e.g., email address, phone number, screen name, etc.) associated with the recipient, where the recipient may use the second electronic device to access the electronic communication.

The recipient may use the second electronic device to select whether to claim the gift card or exchange the gift card, where the second electronic device communicates the selection to the server. Accordingly, the server may determine (block 345) whether the recipient would like to claim or exchange the gift card. If the recipient selects to claim the gift card (“CLAIM”), the server may send (block 355) the redeemable gift code associated with the gift card to the second electronic device. In this regard, the recipient may use the redeemable gift code to facilitate any purchase of a good or service offered by the specified merchant. The server may further notify the first electronic device (and the sender thereof) that the recipient has claimed the gift card.

In contrast, if the recipient selects to exchange the gift card (“EXCHANGE”), the server may determine (block 350) whether the second electronic device has a dedicated application installed thereon. In some implementations, the server may not enable the recipient to exchange the gift card without installing a dedicated gift card processing application. Of course, it should be envisioned that the server may enable the recipient to exchange the gift card without requiring installation of the dedicated application.

If the server determines that the second electronic device does not have the dedicated application installed thereon (“NO”), then the server may send an indication (e.g., a link) of the dedicated application to the second electronic device along with instructions for downloading the dedicated application. The second electronic device may then install the dedicated application and the server may detect (block 360) that the second electronic device has installed the dedicated gift card processing application.

After the second electronic device installs the dedicated application or if the second electronic device already has the dedicated application installed thereon (“YES”), the server may access a set of alternate merchants having available gift cards and may send the set of alternate merchants to the second electronic device so the user of the second electronic device may select an alternate merchant. The second electronic device may send an indication of the alternate merchant to the server, indicating that the recipient wants to switch merchants for the originally-purchased gift card. Accordingly, the server may access (block 365), retrieve, or generate an alternate redeemable gift code associated with the alternate merchant. In some implementations, the server may deactivate the original redeemable gift code. The server may also send (block 370) the alternate redeemable gift code to the second electronic device. In this regard, the recipient may use the alternate redeemable gift code to facilitate any purchase of a good or service offered by the alternate merchant.

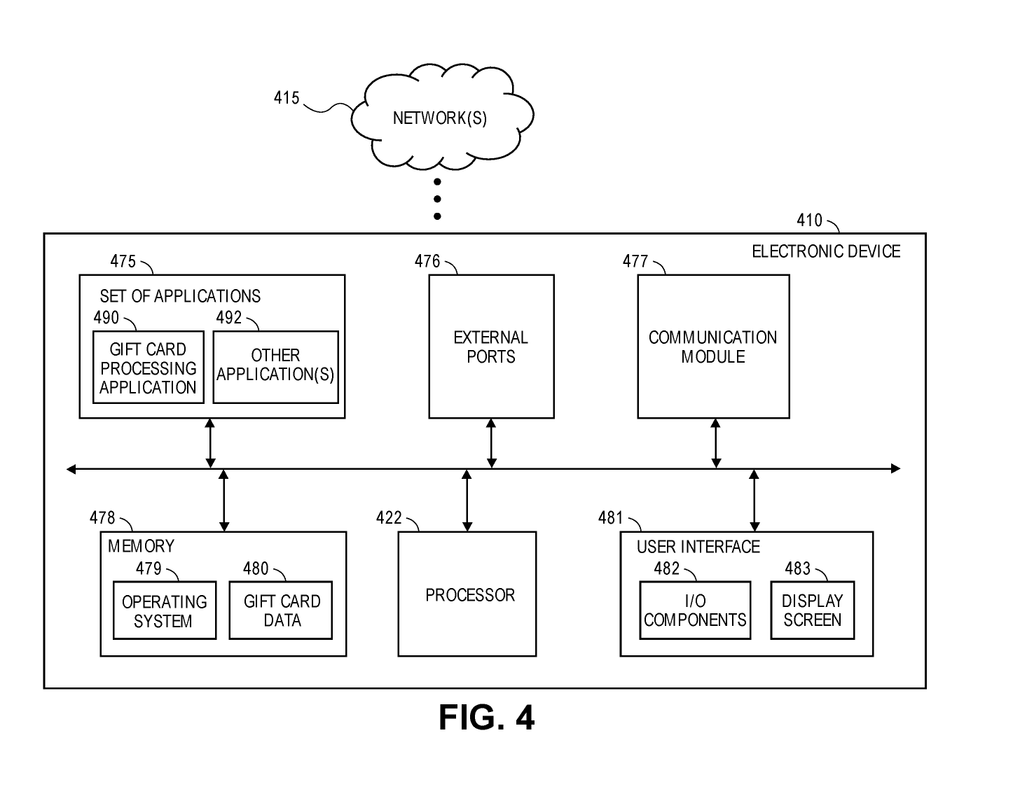

FIG. 4 illustrates a diagram of an exemplary electronic device 410 (such as either of the sending device 105 or the receiving device 110 as discussed with respect to FIG. 1) in which the functionalities as discussed herein may be implemented.

The electronic device 410 may include a processor 422 as well as a memory 478. The memory 478 may store an operating system 479 capable of facilitating the functionalities as discussed herein as well as a set of applications 475 (i.e., machine readable instructions). For example, one of the set of applications 475 may be a gift card processing application 490 configured to enable users to claim or exchange gift cards. It should be appreciated that one or more other applications 492 are envisioned, such as an application associated with an insurance provider.

The processor 422 may interface with the memory 478 to execute the operating system 479 and the set of applications 475. According to some embodiments, the memory 478 may also store gift card data 480 that includes information related to pending or claimed gift cards. A digital wallet module or application of the electronic device 410 (not shown in FIG. 4) may interface with the gift card data 480 to maintain a digital gift card wallet. The memory 478 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The electronic device 410 may further include a communication module 477 configured to communicate data via one or more networks 415. According to some embodiments, the communication module 477 may include one or more transceivers (e.g., WWAN, WLAN, and/or WPAN transceivers) functioning in accordance with IEEE standards, 3GPP standards, or other standards, and configured to receive and transmit data via one or more external ports 476. For example, the communication module 477 may receive, from a back-end server via the network 415, a notification of a gift card purchase. Further, the communication module 477 may include a short-range network component (e.g., an RFID reader) configured for short-range network communications.

The electronic device 410 may further include a user interface 481 configured to present information to a user and/or receive inputs from the user. As shown in FIG. 4, the user interface 481 may include a display screen 482 and I/O components 483 (e.g., ports, capacitive or resistive touch sensitive input panels, keys, buttons, lights, LEDs, speakers, microphones). According to some embodiments, the user may access the electronic device 410 via the user interface 481 to make various selections, log into any of the set of applications 475, and/or perform other functions. In some embodiments, the electronic device 410 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 422 (e.g., working in connection with the operating system 479) to facilitate the functions as described herein. In this regard, the program code may be implemented in any desired language, and may be implemented as machine code, assembly code, byte code, interpretable source code or the like (e.g., via C, C++, Java, Actionscript, Objective-C, Javascript, CSS, XML). In some embodiments, the computer program product may be part of a cloud network of resources.

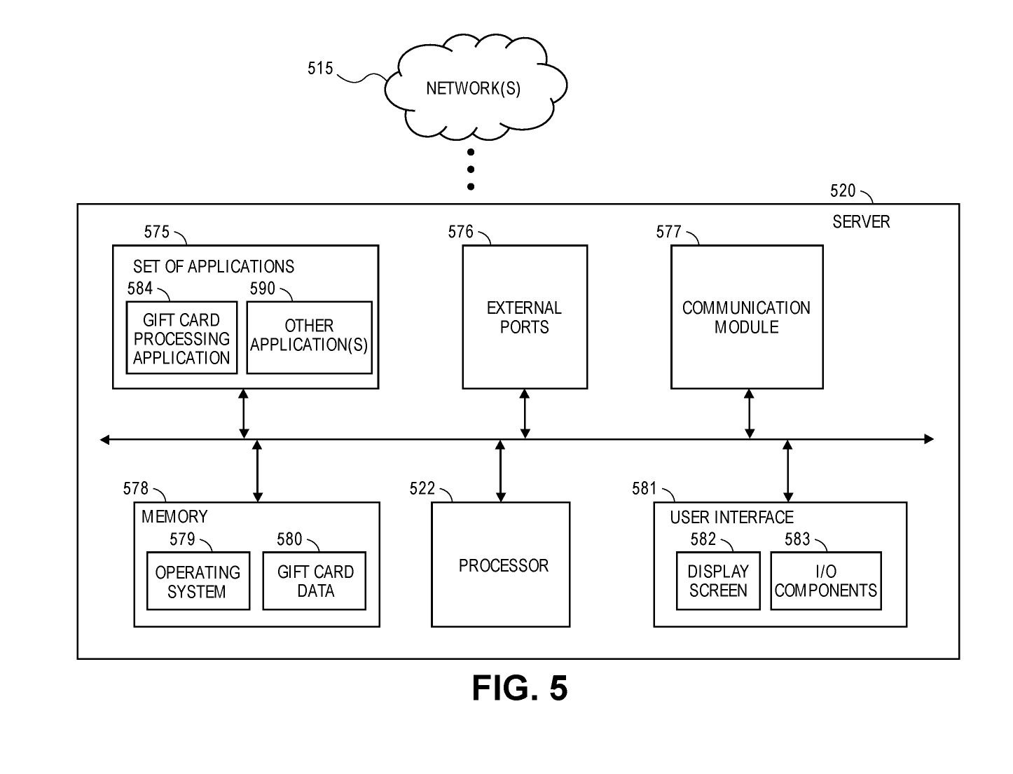

FIG. 5 illustrates a diagram of an exemplary server 520 (such as the application server 120 or the payment server 125 as discussed with respect to FIG. 1) in which the functionalities as discussed herein may be implemented.

The server 520 may include a processor 522, as well as a memory 578. The memory 578 may store an operating system 579 capable of facilitating the functionalities as discussed herein as well as a set of applications 575 (i.e., machine readable instructions). For example, one of the set of applications 575 may be a gift card processing application 584 configured to facilitate the purchasing, claiming, and exchanging of gift cards. It should be appreciated that one or more other applications 590 are envisioned, such as an application associated with an insurance provider.

The processor 522 may interface with the memory 578 to execute the operating system 579 and the set of applications 575. According to some embodiments, the memory 578 may also gift card data 580 that includes various information about claimed or unclaimed gift cards, as well as inventory information of gift cards that may be offered by merchants. The gift card processing application 584 may access the gift card data 580 to facilitate the purchasing, claiming, and exchanging of gift cards. The memory 578 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The server 520 may further include a communication module 577 configured to communicate data via one or more networks 515. According to some embodiments, the communication module 577 may include one or more transceivers (e.g., WWAN, WLAN, and/or WPAN transceivers) functioning in accordance with IEEE standards, 3GPP standards, or other standards, and configured to receive and transmit data via one or more external ports 576. For example, the communication module 577 may receive, via the network 515, requests to purchase and/or exchange gift cards. The server 520 may further include a user interface 581 configured to present information to a user and/or receive inputs from the user. As shown in FIG. 5, the user interface 581 may include a display screen 582 and I/O components 583 (e.g., ports, capacitive or resistive touch sensitive input panels, keys, buttons, lights, LEDs, speakers, microphones). According to some embodiments, the user may access the server 520 via the user interface 581 to process various user accounts and/or perform other functions. In some embodiments, the server 520 may perform the functionalities as discussed herein as part of a “cloud” network or may otherwise communicate with other hardware or software components within the cloud to send, retrieve, or otherwise analyze data.

It should be appreciated that the server 120 may include specialized (i.e., non-generic) or dedicated components capable of performing specialized (i.e., non-generic) or dedicated computer functions. In particular, the server 120 may include a token generation module configured to generate and/or manage various tokens associated with the systems and methods, including the tracking token(s), the client token(s), and the payment token(s). Further, the server 120 may include a gift code generation module configured to generate and/or manage the gift codes associated with the gift cards. Each of the specialized or dedicated components may be configured to be executed by the processor 522.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 522 (e.g., working in connection with the operating system 579) to facilitate the functions as described herein. In this regard, the program code may be implemented in any desired language, and/or may be implemented as machine code, assembly code, byte code, interpretable source code or the like (e.g., via C, C++, Java, Actionscript, Objective-C, Javascript, CSS, XML). In some embodiments, the computer program product may be part of a cloud network of resources.

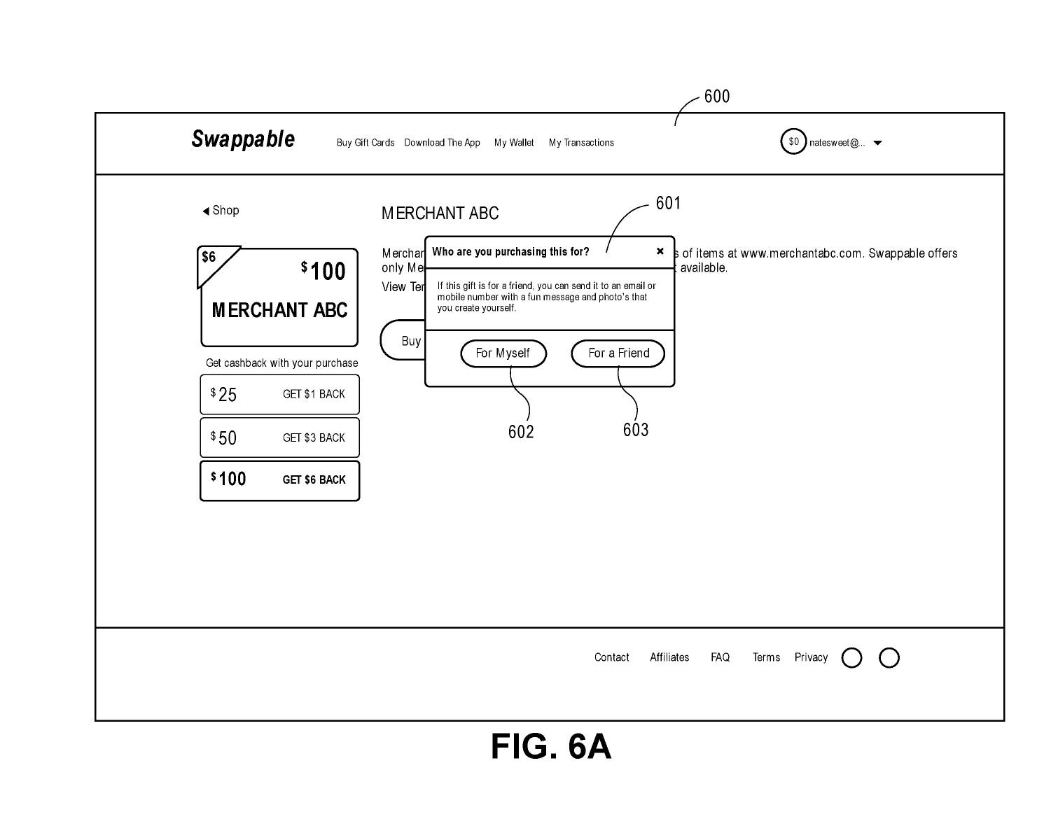

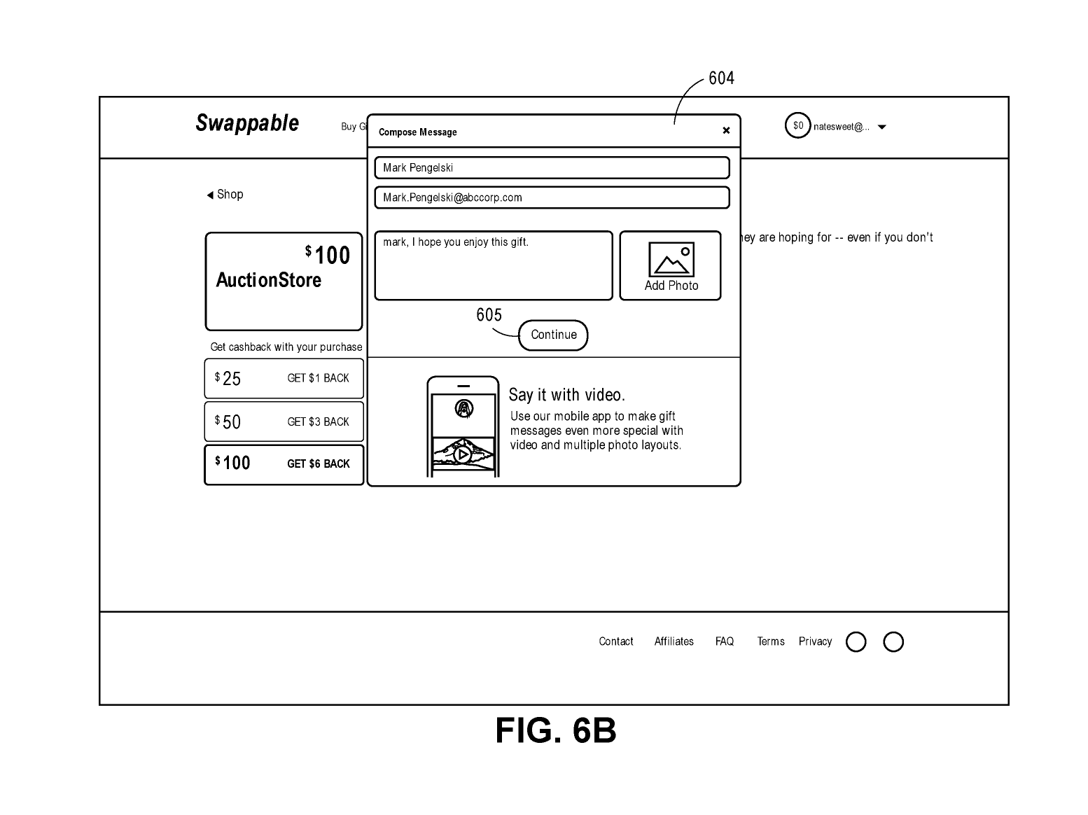

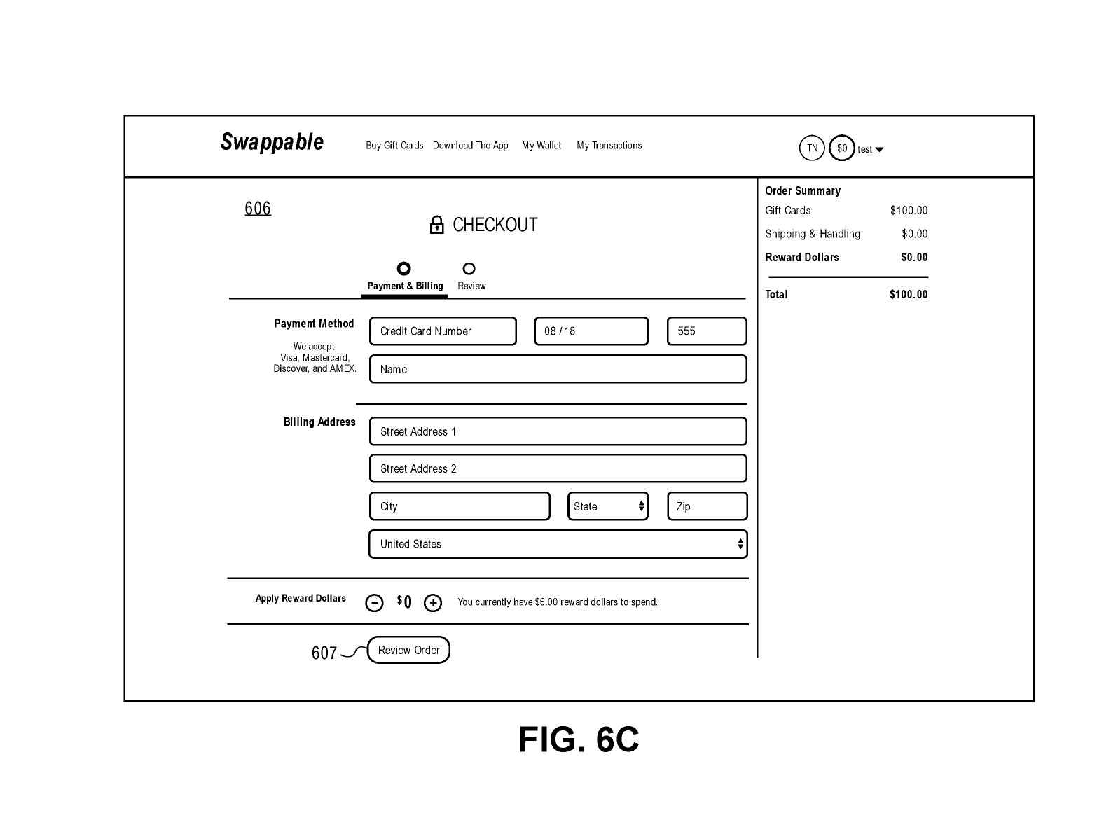

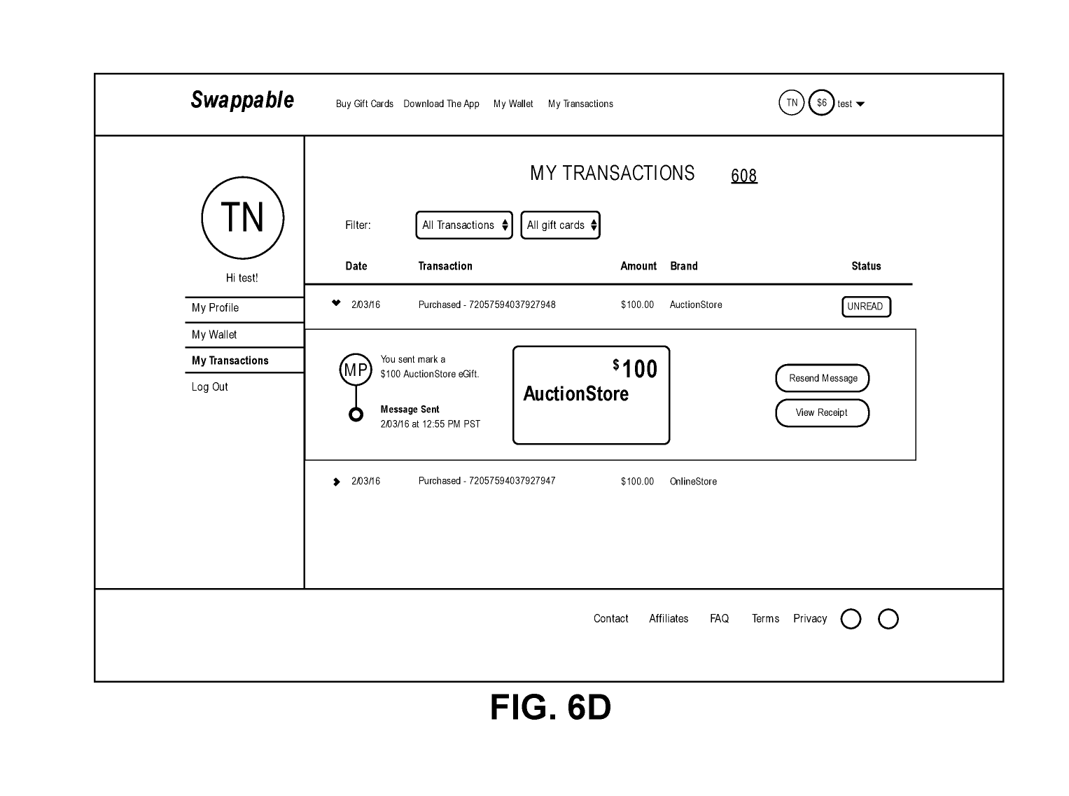

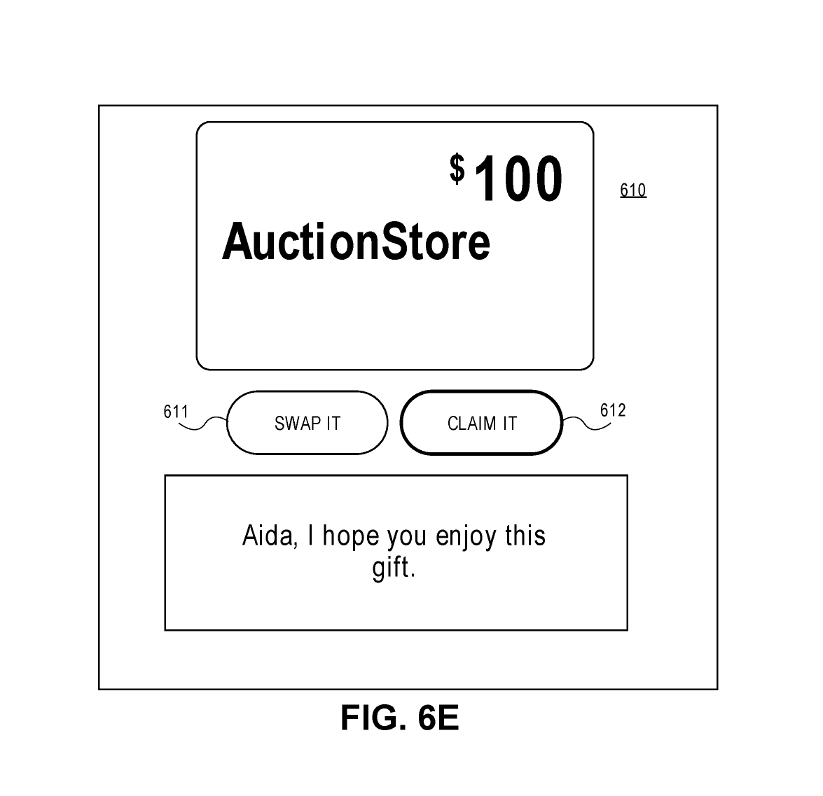

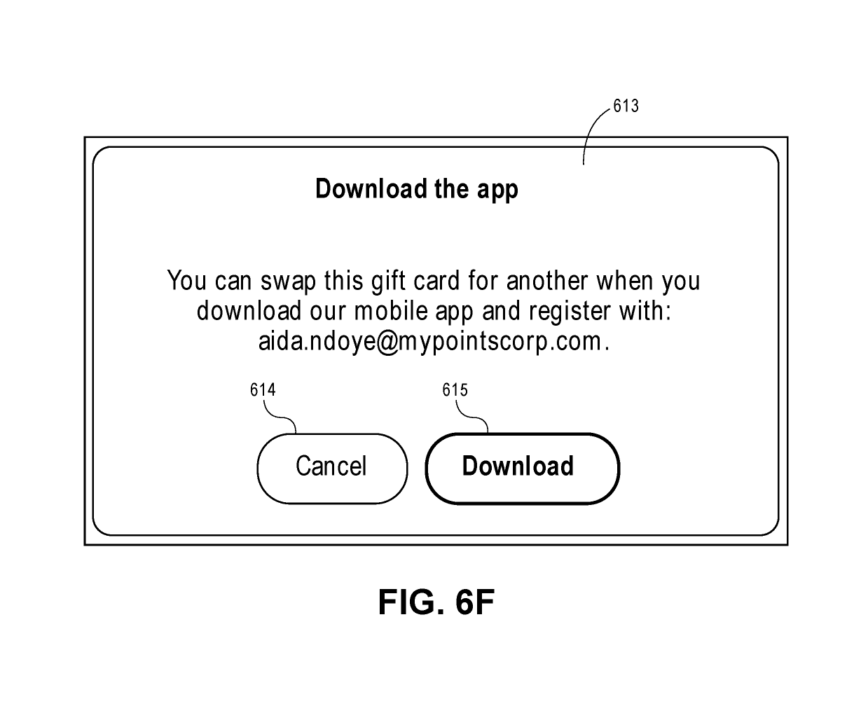

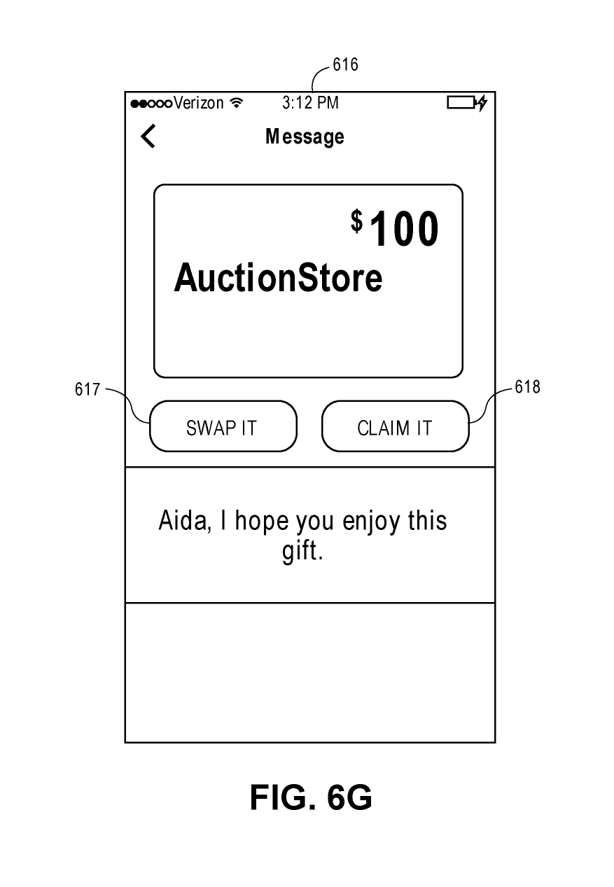

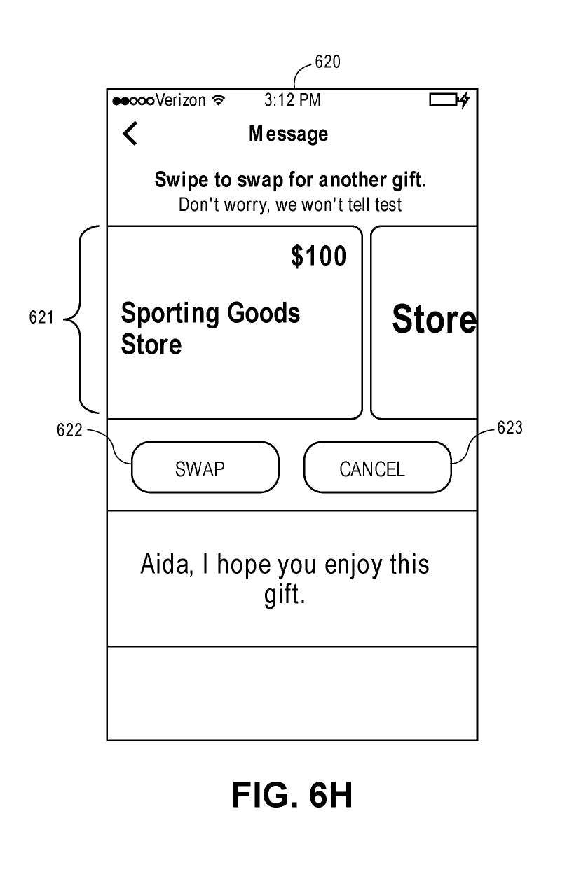

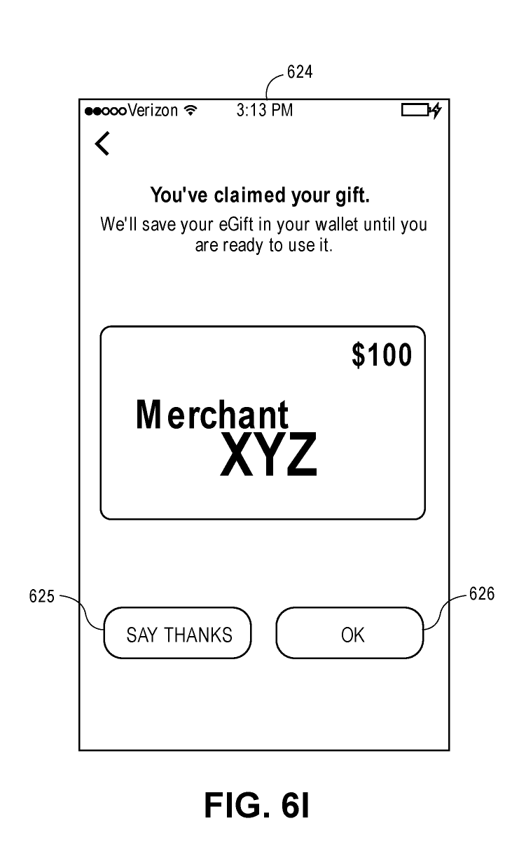

FIGS. 6A-6I illustrate exemplary interfaces associated with exchanging gift cards. One or more electronic devices (e.g., a mobile device, such as a smartphone, or a notebook computer) may be configured to display the interfaces and/or receive selections and inputs via the interfaces, where the electronic device(s) may be associated with either a sending user or a recipient user. For example, a communication platform (e.g., a web browser) or a dedicated application that is configured to operate on the electronic device may display the interfaces. It should be appreciated that the interfaces are merely exemplary and that alternative or additional content is envisioned.

FIG. 6A illustrates an interface 600 displayable by an electronic device of a sending user, and associated with enabling the sending user to purchase a gift card. The interface 600 may enable the sending user to select various information associated with the gift card, including a redemption amount or denomination, and a merchant. The interface 600 may display a window 601 that queries whether the gift card is for the sending user (i.e., the sending user is purchasing the gift card for him/herself) or for a receiver user. The sending user may select a “For Myself” selection 602 if the gift card is for the sending user or a “For a Friend” selection 603 if the gift card is for a receiver user.

If the sending user selects the “For a Friend” selection 603, the electronic device may display a window 604 as illustrated in FIG. 6B that may enable the sending user to input information associated with the receiver user. In particular, the window 604 as illustrated in FIG. 6B enables the sending user to input a name, a communication channel (e.g., an email address), a message, and a photo. It should be appreciated that the sending user may input alternate or additional information. After inputting the information, the sending user may select a “Continue” selection 605 that may cause the electronic device to facilitate additional processing related to the purchase of the gift card.

FIG. 6C illustrates a checkout interface 606 that may enable the sending user to input payment information associated with payment of the gift card for the receiver user. After inputting the payment information, the sending user may select a “Review Order” selection 607 that may enable the sending user to review the order for the gift card, and ultimately enable the electronic device to complete a purchase of the gift card for the receiver user.

FIG. 6D illustrates an interface 608 that may indicate transactions or purchases completed by the sending user, and information associated therewith. In particular, the interface 608 indicates a purchase of a gift card in the amount of $100 on February 3. The interface 608 further indicates that the gift card (in the form of a message) was sent to the receiver user.

FIG. 6E illustrates an interface 610 that may be displayed on an electronic device of the receiver user. In embodiments, the electronic device may display the interface 610 after the sending user purchases the gift card for the receiver user. The interface 610 may be included as part of an electronic communication (e.g., an email sent to the email address indicated in FIG. 6B). The interface 610 may indicate the gift card (as shown: $100 to a merchant), and enable the receiver user to swap or exchange the gift card via a “Swap It” selection 611, or claim the gift card via a “Claim It” selection 612. If the receiver user selects the “Claim It” selection 612, the electronic device may facilitate functionality for the receiver user to claim the gift card.

If the receiver user selects the “Swap It” selection 611, the electronic device may optionally determine whether a dedicated application is installed thereon, and if not, the electronic device may display an interface 613 as illustrated in FIG. 6F. The interface 613 may enable the receiver user to dismiss the interface 613 via a “Cancel” selection 614, or download the application via a “Download” selection 615. If the receiver user selects the “Download” selection 615, the electronic device may initiate a download of the dedicated application. In some implementations, the dedicated application may not be needed to claim or swap the gift card. Further, in some implementations if the dedicated application is already installed on the electronic device, the electronic device may automatically launch the application in response to the receiver user selecting the “Claim It” selection 612 or the “Swap It” selection 611.

FIG. 6G illustrates an interface 616 that may be displayed by the electronic device within the dedicated application. In embodiments, the electronic device may display the interface 616 after downloading and installing the dedicated application. The interface 616 may indicate the gift card (as shown: $100 to a merchant), and, similar to the interface 610 of FIG. 6E, enable the receiver user to swap or exchange the gift card via a “Swap It” selection 617, or claim the gift card via a “Claim It” selection 618. If the receiver user selects the “Claim It” selection 618, the electronic device may facilitate functionality for the receiver user to claim the gift card.

If the receiver user selects the “Swap It” selection 617, the electronic device may display an interface 620 as depicted in FIG. 6H, where the interface 620 may also be associated with the dedicated application. The interface 620 enables the receiver user to, within a dedicated area 621, browse and select gift cards associated with additional merchants different from the original merchant specified in the purchased gift card. The interface 620 enables the receiver user to cancel the swapping functionality via a “Cancel” selection 623. Alternatively, after the receiver user selects an alternate gift card in the area 621, the receiver user may select the “Swap” selection 622 to cause the electronic device to initiate processing associated with exchanging or swapping the original gift card with the alternate gift card.

FIG. 6I illustrates an interface 624 that the electronic device may display after the recipient user selects the “Swap” selection 622 of the interface 620. The interface 624 may indicate that the original gift card has been successfully exchanged or swapped for the alternate gift card. The interface 624 enables the receiver user to send a thank you message to the sending user via a “Say Thanks” selection 625, or dismiss the interface 624 via an “OK” selection 626.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Although the following text sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

What is claimed:

1. A computer-implemented method of implementing a gift card exchange, the method comprising:
receiving, from a first electronic device, a request to purchase a gift card specifying (i) a redemption amount, (ii) a merchant, and (iii) a recipient;
completing, by a processor, a purchase of the gift card with a payment processing entity, the purchase having a redeemable gift code associated therewith;
responsive to completing the purchase:
sending a confirmation of the purchase of the gift card to the first electronic device, and
sending, to a second electronic device associated with the recipient, a reference to the gift card;
receiving, from the second electronic device, an exchange request to switch the merchant of the gift card to an alternate merchant;
accessing an alternate redeemable gift code, for the gift card, associated with the alternate merchant; and
sending the alternate redeemable gift code to the second electronic device.

2. The computer-implemented method of claim 1, further comprising, in response to receiving the request to purchase the gift card:
determining that the gift card is available for purchase;
retrieve, from the payment processing entity, a tracking token and a client token; and
sending the tracking token and the client token to the first electronic device.

3. The computer-implemented method of claim 2, wherein completing the purchase of the gift card with the payment processing entity comprises:
receiving a payment token from the first electronic device; and
completing the purchase of the gift card with the payment processing entity using the tracking token and the payment token.

4. The computer-implemented method of claim 1, wherein receiving the exchange request comprises:
receiving, from the second electronic device, an exchange selection associated with the gift card;
sending, to the second electronic device, an indication of a set of alternate merchants with gift card availability; and
receiving, from the second electronic device, the exchange request indicating the alternate merchant of the set of alternate merchants.

5. The computer-implemented method of claim 1, wherein accessing the alternate redeemable gift code comprises:
generating the alternate redeemable gift code; and
invalidating the redeemable gift code.

6. The computer-implemented method of claim 1, wherein responsive to completing the purchase, further comprising:
sending, to the first electronic device, a temporary gift code that is mapped to the redeemable gift code.

7. The computer-implemented method of claim 1, further comprising:
receiving, from the second electronic device, an indication that a dedicated gift card processing application is not installed on the second electronic device; and
sending, to the second electronic device, a link to download the dedicated gift card processing application.

8. The computer-implemented method of claim 7, further comprising:
detecting that the second electronic device has installed the dedicated gift card processing application; and
enabling the second electronic device to submit the exchange request via the dedicated gift card processing application.

9. The computer-implemented method of claim 1, further comprising:
associating the alternate redeemable gift code with an account of the recipient.

10. The computer-implemented method of claim 1, wherein sending the reference to the gift card comprises:
sending, to the recipient, an electronic communication including the reference to the gift card.

11. A system for implementing a gift card exchange, comprising:
a transceiver configured to communicate with a first electronic device associated with a sending user, a second electronic device associated with a recipient user, and a payment processing entity;
a memory storing (i) a set of computer-executable instructions and (ii) a set of gift card processing data; and
a processor configured to interface with the transceiver and the memory, and configured to execute the set of computer-executable instructions to cause the processor to:
receive, from the first electronic device via the transceiver, a request to purchase a gift card specifying (i) a redemption amount, (ii) a merchant, and (iii) the recipient user,
complete a purchase of the gift card with the payment processing entity, the purchase having a redeemable gift code associated therewith,
responsive to completing the purchase:
send, to the first electronic device via the transceiver, a confirmation of the purchase of the gift card to the first electronic device, and
send, to the second electronic device via the transceiver, a reference to the gift card,
receive, from the second electronic device via the transceiver, an exchange request to switch the merchant of the gift card to an alternate merchant,
access an alternate redeemable gift code, for the gift card, associated with the alternate merchant, and
send the alternate redeemable gift code to the second electronic device via the transceiver.

12. The system of claim 11, where in response to receiving the request to purchase the gift card, the processor is configured to execute the set of computer-executable instructions to cause the processor to:
determine, from the set of gift card processing data, that the gift card is available for purchase,
retrieve, from the payment processing entity, a tracking token and a client token, and
send the tracking token and the client token to the first electronic device via the transceiver.

13. The system of claim 12, wherein to complete the purchase of the gift card with the payment processing entity, the processor is configured to:
receive a payment token from the first electronic device, and
complete the purchase of the gift card with the payment processing entity using the tracking token and the payment token.

14. The system of claim 11, wherein to receive the exchange request, the processor is configured to:
receive, from the second electronic device via the transceiver, an exchange selection associated with the gift card,
identify, from the set of gift card processing data, a set of alternate merchants with gift card availability,
send, to the second electronic device via the transceiver, an indication of the set of alternate merchants, and
receive, from the second electronic device via the transceiver, the exchange request indicating the alternate merchant of the set of alternate merchants.

15. The system of claim 11, wherein to access the alternate redeemable gift code, the processor is configured to:
generate the alternate redeemable gift code, and
invalidate the redeemable gift code.

16. The system of claim 11, wherein in response to completing the purchase, the processor is configured to execute the set of computer-executable instructions to cause the processor to:
send, to the first electronic device via the transceiver, a temporary gift code that is mapped to the redeemable gift code.

17. The system of claim 11, wherein the processor is configured to execute the set of computer-executable instructions to further cause the processor to:
receive, from the second electronic device via the transceiver, an indication that a dedicated gift card processing application is not installed on the second electronic device, and
send, to the second electronic device via the transceiver, a link to download the dedicated gift card processing application.

18. The system of claim 17, wherein the processor is configured to execute the set of computer-executable instructions to further cause the processor to:
detect that the second electronic device has installed the dedicated gift card processing application, and
enable the second electronic device to submit the exchange request via the dedicated gift card processing application.

19. The system of claim 11, wherein the processor is configured to execute the set of computer-executable instructions to further cause the processor to:
associate the alternate redeemable gift code with an account of the recipient.

20. The system of claim 11, wherein to send the reference to the gift card, the processor is configured to:
send, to the recipient, an electronic communication including the reference to the gift card.
